(19) United States
(12) Patent Application Publication
(10) Pub. No.: US 2025/0273754 A1
(43) Pub. Date: Aug. 28, 2025

(54) BATTERY CASE AND A BATTERY SYSTEM INCLUDING THE SAME

(71) Applicants: HYUNDAI MOTOR COMPANY, Seoul (KR); KIA CORPORATION, Seoul (KR)

(72) Inventors: Young Hoo Oh, Daejeon (KR); Seok Eun Yoon, Seoul (KR); Yu Ri Oh, Hwaseong-si (KR); In Gook Son, Incheon (KR)

(73) Assignees: HYUNDAI MOTOR COMPANY, Seoul (KR); KIA CORPORATION, Seoul (KR)

(21) Appl. No.: 18/799,092

(22) Filed: Aug. 9, 2024

(30) Foreign Application Priority Data
Feb. 26, 2024 (KR) 10-2024-0027376

(51) Int. Cl. H01M 10/42; H01M 10/48; H01M 50/204; H01M 50/258; H01M 50/298; H01Q 1/32

(52) U.S. Cl. CPC H01M 10/425; H01M 10/482; H01M 50/204; H01M 50/258; H01M 50/298; H01Q 1/325; H01M 2010/4271; H01M 2010/4278

(57) ABSTRACT

A battery case includes: a lower case accommodating a plurality of battery modules therein; a battery management unit (BMU) provided in the lower case and configured to monitor a state of the battery modules; and a communication unit provided at a lateral portion inside the lower case. The communication unit is connected to at least an adjacent battery module with wiring and is configured to transmit information about at least the adjacent battery module to the BMU through wired or wireless communication along a lengthwise or widthwise direction of the lower case.

### CROSS REFERENCE TO RELATED APPLICATION

The present application claims priority to Korean Patent Application No. 10-2024-0027376, filed Feb. 26, 2024, the entire contents of which are incorporated herein for all purposes by this reference.

### BACKGROUND

### Technical Field

The disclosure relates to a battery case and a battery system including the same. More particularly, the present disclosure relates to a battery case capable of transmitting information about a plurality of battery modules to a battery management unit via wireless communication and wired communication.

### Description of the Related Art

With recent issues of carbon dioxide being emitted due to use of fossil fuels, vehicle manufacturers are expanding the proportion of research/development on electric vehicles using a battery as a power source.

A battery used in an electric vehicle is generally a lithium secondary battery. A battery management system (BMS) is mounted together with the battery for the stability, efficient power use, life management, and the like of the battery.

For the management of the battery, it is desired to continuously monitor the state of battery cells and modules. To this end, a communication circuit is provided between a battery management unit (BMU) and the battery modules.

### SUMMARY

An aspect of the present disclosure is to provide a battery case, in which a combination of wireless communication and wired communication is used to transmit information about battery cells and battery modules to a battery management unit.

According to an embodiment of the disclosure, a battery case includes a battery lower case (i.e., a lower case) accommodating a plurality of battery modules therein. The battery case also includes a battery management unit (BMU) provided in the battery lower case and configured to monitor a state of the battery modules. The battery case also includes a communication unit provided at a lateral portion inside the battery lower case and connected to an adjacent battery module with wiring. The communication unit is configured to transmit information about the battery modules to the BMU through wired or wireless communication along a lengthwise or widthwise direction of the battery lower case.

The battery case may further include a transverse member provided inside the battery lower case and positioned across the battery lower case in the widthwise direction. The communication unit may include a first antenna module provided at an edge of the battery lower case and connected to an adjacent battery module with the wiring. The first antenna module may be configured to transmit information about the adjacent battery module to the BMU. The communication unit may also include a second antenna module provided in a space above an end portion of the transverse member and connected to another adjacent battery module with the wiring. The second antenna module may be configured to transmit information about the other adjacent battery module to the BMU or to the first antenna module.

The first antenna module or the second antenna module may include an antenna configured to transmit and receive a signal and may include a protection cover for covering the antenna.

The battery case may further include a reinforcing member provided on a top of the transverse member and configured to provide support between the battery modules. The second antenna module may be provided above the reinforcing member.

The battery lower case may include a first transverse member and a second transverse member that is spaced apart from the first transverse member. The second antenna module may be provided in a space above an end portion of the second transverse member.

The first transverse member may be positioned between the second transverse member and the BMU. An end portion of the first transverse member may be bent downward at a point extending in the widthwise direction.

The battery case may further include a side member provided on a lateral side of the battery lower case and extending in the lengthwise direction of the battery lower case. The plurality of battery modules and the side member may be spaced apart at a predetermined distance from each other. The battery case may also include a communication space extending in the lengthwise direction of the battery lower case that is formed between the plurality of battery modules and the side member.

The communication unit may be configured to transmit information about the plurality of battery modules to the BMU through the communication space.

The battery case may further include a battery upper case (i.e., an upper case) covering a top of the battery lower case in which the plurality of battery modules is accommodated. Additionally, a gap between the plurality of battery modules and the side member may be larger than a gap between the plurality of battery modules and the battery upper case.

The first antenna module may be provided at the edge of the battery lower case adjacent to the BMU. The first antenna module and the second antenna module may be located at different heights.

The first antenna module may be located at a lower height than the second antenna module.

The first antenna module may be connected to the BMU with the wiring and may be configured to transmit at least one of information about the plurality of battery modules received from the second antenna module or information about the plurality of battery modules connected to the first antenna module to the BMU.

The BMU may include a third antenna module. The first antenna module may be configured to transmit at least one of information about the plurality of battery modules received from the second antenna module or information about the plurality of battery modules connected to the first antenna module to the third antenna module.

The plurality of battery modules may be arranged in three rows along the lengthwise direction of the battery lower case.

A second-row of battery modules and a third-row of battery modules may be connected to the second antenna module with the wiring. A first-row of battery modules may be connected to the first antenna module with the wiring.

Each of the first antenna module and the second antenna module may include a pair of antenna modules. The first antenna modules may be provided at the edges of the front of the battery lower case adjacent to the BMU. The second antenna modules may be provided in spaces above opposite end portions of the transverse member.

The wiring connecting the battery module and the communication unit may be drawn out in the widthwise direction of the battery lower case and connected to the communication unit.

With the battery case according to the disclosure, a combination of the wireless communication and the wired communication may be used to transmit information about the battery cells and the battery modules.

In particular, an empty space on a lateral side or between the battery modules of the existing battery case may be utilized for the wired or wireless communication. In other words, there is room for utilizing a space below the battery upper case or a space above the battery module, and that space may be utilized to improve the performance of the battery.

### BRIEF DESCRIPTION OF THE DRAWINGS

FIG. 1 is a top view of a battery lower case of a battery case according to an embodiment of the disclosure.

FIG. 2 is a partially enlarged view of a battery lower case according to an embodiment of the disclosure.

FIG. 3 illustrates a portion of a battery lower case to describe communication between a battery management unit (BMU) and first and second antenna modules according to an embodiment of the disclosure.

FIG. 4 is a cross-sectional view of a battery case including a second antenna module according to an embodiment of the disclosure.

FIG. 5 illustrates a partial widthwise cross-section of a battery case (taken along line A-A′ in FIG. 1).

FIG. 6 illustrates an embodiment of a battery case where a first antenna module and a BMU are connected with a wire.

FIG. 7 illustrates an embodiment of a battery case where wireless communication is possible between a third antenna module provided in a BMU and a first antenna module.

### DETAILED DESCRIPTION

Hereinafter, embodiments of the disclosure are described in detail with reference to the accompanying drawings. The same or similar elements are denoted by the same reference numerals even though they are depicted in different drawings and redundant descriptions thereof have been omitted.

In terms of describing the embodiments of the disclosure, detailed descriptions of related art have been omitted where they may have made the subject matter of the embodiments of the disclosure rather unclear. In addition, the accompanying drawings are provided only to better understand the embodiments of the disclosure and are not intended to limit technical ideas of the disclosure. Therefore, it should be understood that the accompanying drawings include all modifications, equivalents, and substitutions within the scope and spirit of the disclosure.

Terms such as “first” and “second” may be used to describe various components, but the components should not be limited by the above terms. In addition, the above terms are used only for the purpose of distinguishing one component from another.

Unless the context clearly dictates otherwise, singular forms include plural forms as well.

In the disclosure, it should be understood that terms “include”, “comprise”, or “have” and variations thereof indicate that a feature, a number, a step, an operation, an element, a part, or the combination thereof described in the embodiments is present. However, it should be understood in advance that the terms do not preclude a possibility of the presence or addition of one or more other features, numbers, steps, operations, elements, parts, or combinations thereof.

Suffixes such as “module” and “unit” in the following description are given in consideration of simplifying the description and do not have meaning or functions discriminated from each other.

When it is described that one component is “connected” or “joined” to another component, it should be understood that the one component may be directly connected or joined to the other component, but additional components may be present therebetween. However, when one component is described as being “directly connected,” or “directly coupled” to another component, it should be understood that additional components may be absent between the one component and the other component.

When a controller, component, device, element, part, unit, module, or the like of the present disclosure is described as having a purpose or performing an operation, function, or the like, the controller, component, device, element, part, unit, or module should be considered herein as being “configured to” meet that purpose or perform that operation or function. Each controller, component, device, element, part, unit, module, and the like may separately embody or be included with a processor and a memory, such as a non-transitory computer-readable media, as part of the apparatus.

According to the disclosure, a battery case includes a battery lower case (i.e., a lower case) 100 accommodating a plurality of battery modules 200 therein. The battery case includes a battery management unit (BMU) 500 provided in the battery lower case 100 and configured to monitor the state of the battery modules 200. Additionally, the battery case includes a communication unit 50 provided at a lateral portion inside the battery lower case 100 and connected to at least an adjacent battery module of the plurality of battery modules 200 with a wire or wires W, i.e., wiring. The communication unit 50 is configured to transmit information about at least the adjacent battery module of the battery modules 200 to the BMU through wired or wireless communication along a lengthwise or widthwise direction of the battery lower case 100.

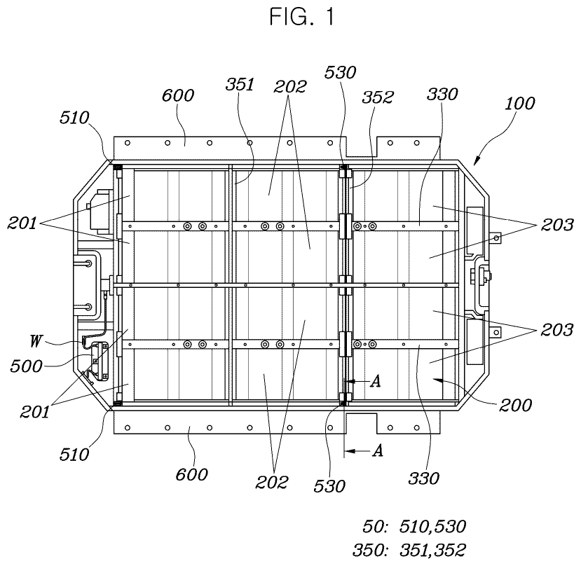

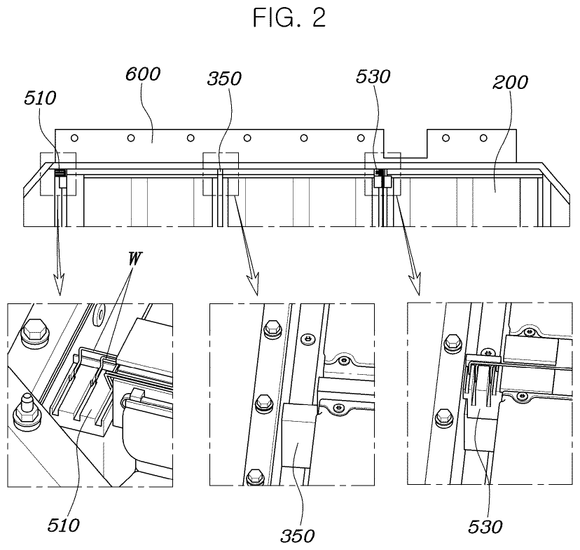

FIG. 1 is a top view of a battery lower case in a battery case according to an embodiment of the disclosure. FIG. 2 is a partially enlarged view of a battery lower case.

Referring to FIGS. 1 and 2, the battery lower case 100 refers to a space in which the plurality of battery modules 200 is accommodated. Inside the battery lower case 100, a longitudinal member 330 may be provided along the battery lower case 100 in the lengthwise direction of the battery lower case 100. Additionally, inside the battery lower case 100, a transverse member 350 may be provided across the battery lower case 100 in the widthwise direction of the battery lower case 100.

As depicted in FIGS. 1 and 2, the battery lower case 100 may include a plurality of the longitudinal members 330 and a plurality of the transverse members 350. The battery lower case 100 is internally partitioned into spaces by the longitudinal members 330 and the transverse members 350. The battery modules 200 are accommodated in the spaces partitioned by the longitudinal members 330 and the transverse members 350.

Furthermore, the BMU 500 is provided inside the battery lower case 100 and monitors the state of the battery modules 200. The BMU 500 refers to a component of a battery management system (BMS) and may monitor the voltage, current, and temperature of battery cells or the battery modules. The BMS may thereby performing various controls depending on monitoring results.

To transmit the monitoring results of the states of the battery modules 200 to the BMU 500, a wired connection may be taken into account. In other words, the monitoring results may be transmitted to the BMU 500 by connecting a sensing block provided in the battery modules 200 and the BMU 500 with a wire W.

However, when wires are used for all the connections, there is no choice but to arrange the wires intricately in the battery case. Therefore, the positions of the battery modules and the BMU are fixed due to the arranged wires.

Although it is difficult to remove all the wires, some wires may be replaced with wireless communication. The removal of some wires offers flexibility in arranging the battery modules and the BMU, thus leaving available space at least equivalent to the volume of the wires replaced with the wireless communication. In particular, the structures for various technologies of improving the performance of the battery may be applied to the space secured due to the removal of the wires.

The wireless communication performed inside the battery case may involve communication interference or signal loss as communication signals are irregularly reflected because a space between a battery lower case 100 and a battery upper case (i.e., upper case) 900 is not large. Accordingly, the disclosure proposes a battery case, the structure of which is adapted to transmit information about the battery modules to the BMU through wireless communication while solving the foregoing problems.

To this end, the communication unit 50 is provided including a first antenna module and a second antenna module, which are described below.

The battery lower case 100 includes a first antenna module 510, which may be connected to at least an adjacent battery module or connected to some of the battery modules 200 with wire W. The first antenna module 510 may be configured to transmit information about the battery modules 200 to which it is connected to the BMU 500. The first antenna module 510 may be provided near the BMU 500 and may transmit information about the corresponding battery modules 200 provided near the BMU 500 to the BMU 500. The first antenna module 510 may be configured to perform wired communication WT or wireless communication WLT with the BMU 500, which is described below.

A second antenna module 530 is connected to at least another adjacent battery module or to some of the battery modules 200 with wire W. The second antenna module 530 may be used in transmitting information about the battery modules 200 to which it is connected to the first antenna module 510 or to the BMU 500. Specifically, the second antenna module 530 is provided in a space above an end portion of one of the transverse members 350 provided in the widthwise direction of the battery lower case 100. The second antenna module 530 is configured to transmit a wireless signal, which carries information about the battery modules 200 to which it is connected, to the first antenna module 510 or to the BMU 500 along the lengthwise direction of the battery lower case 100.

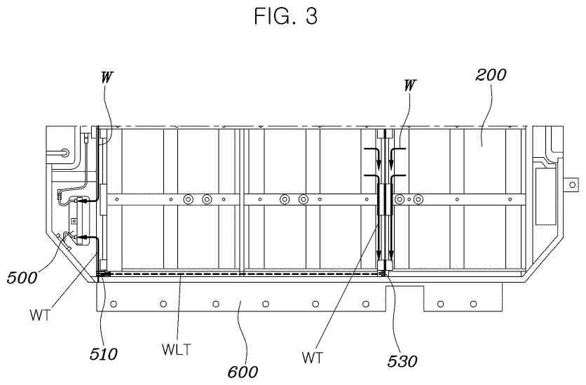

FIG. 3 illustrates a portion of a battery lower case 100 to describe communication between a battery management unit (BMU) 500 and first and second antenna modules 510 and 530. The battery modules 200 adjacent to the second antenna module 530 are connected to the second antenna module 530 with wire W. The second antenna module 530 may collect information about the battery modules 200 and transmit the collected information to the first antenna module 510. In this case, a wireless signal may be transmitted to the first antenna module 510. The wireless signal may travel along the lengthwise direction of the battery lower case 100 so that the first antenna module 510 can receive a communication signal.

In other words, the wireless signal transmitted from the second antenna module 530 may travel toward the first antenna module 510 through an outer side space of the battery lower case 100.

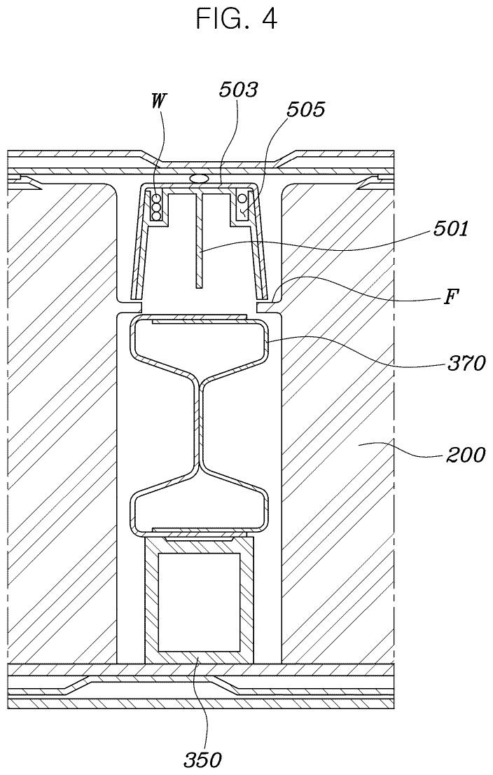

FIG. 4 is a cross-sectional view of a battery case including a second antenna module 530. Referring to FIG. 4, the second antenna module 530 may include an antenna 501 for transmitting a signal and may include a protection cover 503 for covering the antenna 501. The antenna 501 is protected by the outer protection cover 503. The first antenna module 510 may also include an antenna 501 for receiving the signal from the second antenna module 530 and may include a protection cover 503 for protecting the antenna 501.

In addition, the protection cover 503 may be internally provided with an accommodating space 505 to accommodate the wire or wires W connected to the first antenna module 510 or the second antenna module 530.

A reinforcing member 370 configured to provide support between the battery modules 200 may be provided on the top of the transverse member 350. The second antenna module 530 may be provided above the reinforcing member 370. The reinforcing member 370 is provided on the transverse member 350 between the battery modules 200, is configured to support the pressure applied by the battery modules 200, and is coupled with the second antenna module 530. In other words, the second antenna module 530 may be directly coupled to the reinforcing member 370. Alternatively, the second antenna module 530 may be coupled to one side of the battery module 200 through a flange F extending from the battery module 200.

In general, the plurality of battery modules 200 are accommodated in the battery case. To accommodate the plurality of battery modules 200 in the battery lower case 100, the battery lower case 100 may include one or more of the transverse members 350.

Below, specific of the disclosure are described. According to an embodiment of the disclosure, a first transverse member 351 and a second transverse member 352 are provided in the battery lower case 100 and spaced apart from each other. In addition, a second antenna module 530 may be provided in a space above the opposite ends of the second transverse member 352. In other words, a second antenna module 530 may be provided at each end of the second transverse member 352.

The second antenna module 530 is connected to the battery modules 200 that are adjacent to the second antenna module 530 through the wire or wires W. The second antenna module 530 may be connected to one, some, or all the battery modules 200 accommodated in the battery lower case 100. The wire or wires W connecting the second antenna module 530 and the corresponding battery modules 200 may be disposed in the widthwise direction of the battery lower case 100 through a space between the adjacent battery modules 200.

Therefore, the signal carrying the information about the battery modules 200 connected to the second antenna module 530 may travel by wire to the second antenna module 530 along the widthwise direction of the battery lower case 100.

The second antenna module 530 may transmit the wireless signal to the first antenna module 510 or to the BMU 500. The wireless signal may travel through an inner edge of the battery case, which has the least interference with the wireless signal, and more specifically, the outer side space formed in the lengthwise direction of the battery case within an inner space of the battery case.

To provide the space for accommodating the plurality of battery modules 200 therein, a plurality of the transverse members 350 may be provided in the battery lower case 100. The first transverse member 351 may be provided between the second transverse member 352 and the BMU 500.

In other words, the BMU 500, the first transverse member 351, and the second transverse member 352 are sequentially arranged in the battery lower case along the lengthwise direction. The first antenna module 510 may be provided at an edges of the battery lower case 100 adjacent to the BMU 500 or multiple first antenna modules may be provided at the edges to easily communicate with the BMU 500. Therefore, the signal transmitted from the second antenna module or modules 530 located at the end portion or portions of the second transverse member 352 passes through the first transverse member 351. In this case, the wireless signal may have a partial path blocked by the first transverse member 351, or may be irregularly reflected to weaken the strength of the signal received by the first antenna module 510.

To avoid such weakening of the signal strength, the path of the wireless signal may be secured by cutting the appropriate end portion(s) of the first transverse member 351, which is part of the path of the wireless signal. In other words, referring to FIG. 2, the end portions of the first transverse member 351 may be bent downward at a point extending in the widthwise direction.

For convenience of description, it is defined that the first transverse member 351 is provided between the BMU 500 and the second transverse member 352. However, more transverse members may be provided between the BMU 500 and the second transverse member 352 on the assumption that the second transverse member 352 is the rearmost transverse member in the battery lower case 100. In other words, a third transverse member, a fourth transverse member, or more transverse members may be provided between the BMU 500 and the second transverse member 352. The end portions of the additional transverse members between the BMU 500 and the second transverse member 352 may be partially cut to secure the path of the wireless signal.

The battery lower case 100 may include a side member 600 provided on a lateral side thereof and extending in the lengthwise direction of the battery lower case 100 to protect the battery modules 200 from a side collision. In the disclosed embodiment, a side member 600 is provided at each lateral side of the battery lower case 100.

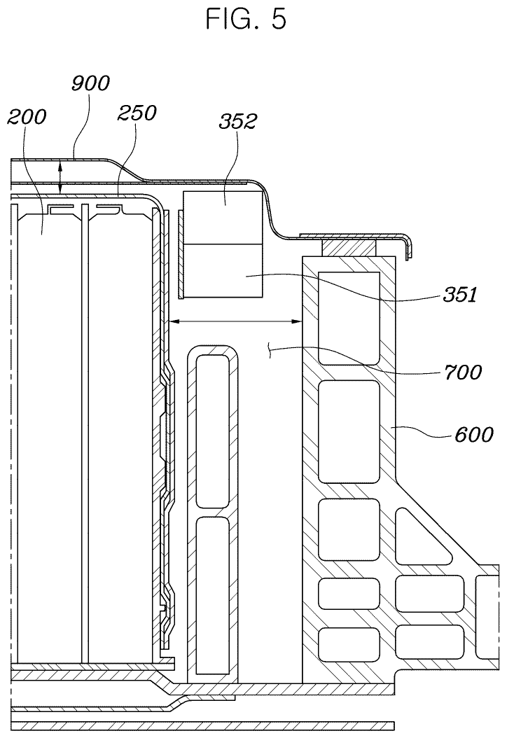

The side member or members 600 may include a mounting portion for absorbing impact applied from the lateral side of the battery and used in mounting the battery case to a vehicle body. FIG. 5 illustrates a partial widthwise cross-section of a battery case. Referring to FIG. 5, a side member 600 is provided on the outermost side of the battery lower case 100, and the battery modules 200 are spaced apart at a predetermined distance from the side member 600. The reason why the battery modules 200 and the side member 600 are spaced apart from each other by a predetermined distance is because the side member 600 needs space and enough time to be deformed by absorbing impact applied thereto when the impact occurs outside the side member 600.

Therefore, a predetermined space is formed between the battery modules 200 and the corresponding side members 600, which are located at the outer sides of the battery lower case 100. The space may be used as a communication space 700 for communication between the first antenna module 510 and the second antenna module 530.

The battery case may further include a battery upper case (i.e., an upper case) 900 that covers the top of the battery lower case 100 in which the battery modules 200 are accommodated. The battery case may also include a gap between the battery modules 200 and the corresponding side members 600 that may be larger than the gap between the battery module 200 and the battery upper case 900.

A gap between an upper cover 250 surrounding battery cells in a battery module 200 and the battery upper case 900 may be narrowed to protect the battery module 200 from vibration. Thus, a side space inside the battery lower case 100 may be used as the communication space 700.

Referring to FIG. 5, for smooth or uninterrupted communication between the first antenna module 510 and the second antenna module 530, the first antenna module 510 and the second antenna module 530 may be located at different heights. With this structure, the inner space of the battery case can be effectively used, so that the wireless communication WLT between the first antenna module 510 and the second antenna module 530 can be smoothly performed.

Specifically, the first antenna module or modules 510 may be provided at the edges of the battery lower case 100 at an end adjacent to the BMU 500. The second antenna module or modules 530 may be provided in a space above the end portions of the transverse member 350. The first antenna module 510 and the second antenna module 530 are positioned at different heights, thereby effectively preventing communication interference from occurring during the wireless communication as compared to positioning them at the same height.

The first antenna module 510 may be located at a lower height than the second antenna module 530, and vice versa. The heights of the first antenna module 510 and the second antenna module 530 may be flexibly adjusted according to relationships with surrounding components.

The first antenna module 510 may receive information about the battery modules 200 from the second antenna module 530. The first antenna module 510 may then transmit the received information to the BMU 500. In this case, information about the battery modules 200 connected to the first antenna module 510 with wire W may also be transmitted to the BMU 500.

However, the first antenna module 510 may be connected to the BMU 500 with wire W and may transmit information about the battery modules 200 to the BMU 500 through the wired communication WT. Alternatively, a third antenna module may be provided in the BMU 500 and transmit information about the battery modules 200 to the BMU 500 through the wireless communication WLT.

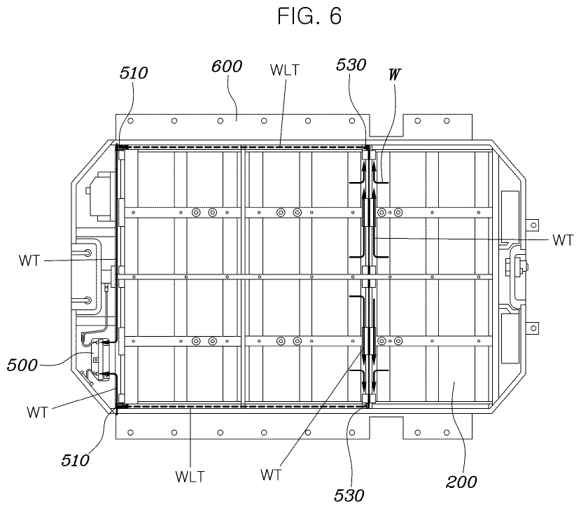

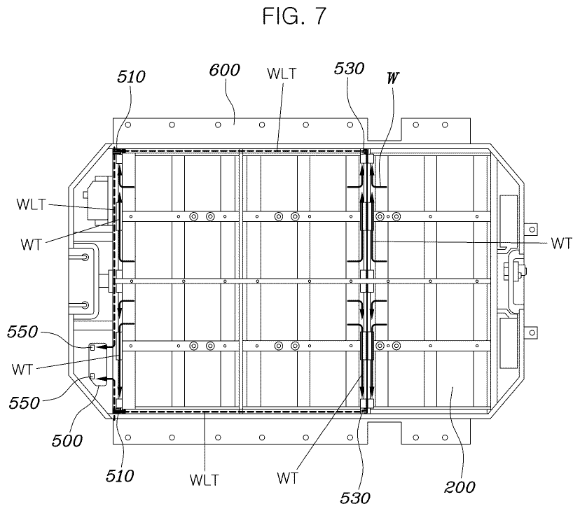

Specifically, FIG. 6 illustrates an embodiment where a first antenna module and a BMU are connected with a wire W. FIG. 7 illustrates an embodiment where wireless communication is possible between a third antenna module provided in a BMU and a first antenna module.

Referring to FIGS. 6 and 7, the two embodiments are the same in that the wireless communication WLT is possible between the first antenna module 510 and the second antenna module 530. The two embodiments are different in that the first antenna module 510 finally transmits information about the battery modules 200 to the BMU 500. The first antenna module 510 and the BMU 500 may perform the wired communication WT therebetween through wire W, or the first antenna module 510 and the BMU 500 may perform the wireless communication WLT therebetween through the third antenna module 550.

Below, a specific embodiment of the disclosure is described with reference to FIG. 1.

The plurality of battery modules 200 may be arranged in three rows along the lengthwise direction of the battery lower case 100. A first-row of battery modules 201, a second-row of battery modules 202, and a third-row of battery modules 203 are arranged in sequence from a front end of the battery lower case 100.

The second-row of battery modules 202 and the third-row of battery modules 203 may be connected to the second antenna module or modules 530 with wire W. The first-row of battery modules 201 may be connected to the first antenna module or modules 510 with wire W. Alternatively, the first-row of battery modules 201 and the second-row of battery modules 202 may be connected to the first antenna module or modules 510, and the third-row of battery modules 203 may be connected to the second antenna module or modules 530. However, to minimize the use of wire W and efficiently dispose the wire W, it is preferable to use the wire W as in the former connection.

Each of the first antenna module 510 and the second antenna module 530 may be provided as a single antenna module. However, each of the first antenna module 510 and the second antenna module 530 may be provided as a plurality of antenna modules, preferably, a pair of antenna modules, according to the number of battery modules 200 arranged in each row.

In other words, the first antenna modules 510 may be respectively provided at the side edges at the front of the battery lower case 100 adjacent to the BMU 500, thereby forming a pair. The second antenna modules 530 may be respectively provided in the spaces above the opposite end portions of the transverse member 350, such as the rearmost transverse member 350, thereby forming a pair.

Further, the wires W connecting the battery modules 200 and the first antenna module or modules 510 or the second antenna module or modules 530 may be drawn out in the widthwise direction of the battery lower case 100 and connected to the first antenna module 510 or the second antenna module 530.

With the foregoing battery case according to the disclosure, the inner space of the existing battery case is used for a combination of the wireless communication and the wired communication to transmit information about the battery modules to the BMU.

In particular, a space inside the battery case between the battery modules and each side member is utilized for wireless communication with minimum change in the structure of the battery case. Further, there is no need to change the structure of the battery modules or the battery upper case. Thus, it is possible to improve the performance of the battery by utilizing the space below the battery upper case or the space above the battery modules.

Although specific embodiments of the disclosure have been illustrated and described above, various modifications and changes can be made by a person having ordinary skill in the art without departing from the scope of the technical ideas defined by the appended claims.

What is claimed is:

1. A battery case comprising:
a lower case accommodating a plurality of battery modules therein;
a battery management unit (BMU) provided in the lower case and configured to monitor a state of the plurality of battery modules; and
a communication unit provided at a lateral portion inside the lower case, connected to an adjacent battery module of the plurality of battery modules with wiring, and configured to transmit information about the adjacent battery module to the BMU through wired or wireless communication along a lengthwise or widthwise direction of the lower case.

2. The battery case of claim 1, further comprising a transverse member provided inside the lower case and positioned across the lower case in a widthwise direction, wherein the communication unit includes:
a first antenna module provided at an edge of the lower case, connected to an adjacent battery module of the plurality of battery modules with the wiring, and configured to transmit information about the adjacent battery module to the BMU; and
a second antenna module provided in a space above an end portion of the transverse member, connected to another adjacent battery module of the plurality of battery modules with the wiring, and configured to transmit information about the other adjacent battery module to the BMU or the first antenna module.

3. The battery case of claim 2, wherein the first antenna module or the second antenna module comprises:
an antenna configured to transmit and receive a signal; and
a protection cover for covering the antenna.

4. The battery case of claim 2, further comprising a reinforcing member provided on a top of the transverse member and configured to provide support between the plurality of battery modules, wherein the second antenna module is provided above the reinforcing member.

5. The battery case of claim 2, wherein the lower case comprises a first transverse member and a second transverse member that is spaced apart from the first transverse member, and wherein the second antenna module is provided in a space above an end portion of the second transverse member.

6. The battery case of claim 5, wherein the first transverse member is positioned between the second transverse member and the BMU, and wherein an end portion of the first transverse member is bent downward at a point extending in the widthwise direction.

7. The battery case of claim 2, wherein the first antenna module is provided at the edge of the lower case adjacent to the BMU, and wherein the first antenna module and the second antenna module are located at different heights.

8. The battery case of claim 7, wherein the first antenna module is located at a lower height than the second antenna module.

9. The battery case of claim 2, wherein the first antenna module is connected to the BMU with the wiring, and is configured to transmit at least one of information about the plurality of battery modules received from the second antenna module or information about the plurality of battery modules connected to the first antenna module to the BMU.

10. The battery case of claim 2, wherein the BMU comprises a third antenna module, and wherein the first antenna module is configured to transmit at least one of information about the plurality of battery modules received from the second antenna module or information about the plurality of battery modules connected to the first antenna module to the third antenna module.

11. The battery case of claim 2, wherein the plurality of battery modules is arranged in three rows along the lengthwise direction of the lower case.

12. The battery case of claim 11, wherein a second-row of the plurality of battery modules and a third-row of the plurality of battery modules are connected to the second antenna module with the wiring, and wherein a first-row of the plurality of battery modules is connected to the first antenna module with the wiring.

13. The battery case of claim 11, wherein each of the first antenna module and the second antenna module comprises a pair of antenna modules, wherein the first antenna modules are provided at the edges of a front of the lower case adjacent to the BMU, and wherein the second antenna modules are provided in spaces above opposite end portions of the transverse member.

14. The battery case of claim 1, wherein the wiring connecting the plurality of battery modules and the communication unit is drawn out in the widthwise direction of the lower case and connected to the communication unit.

15. The battery case of claim 1, further comprising:
a side member provided on a lateral side of the lower case and extending in the lengthwise direction of the lower case, wherein the plurality of battery modules and the side member are spaced apart at a predetermined distance from each other; and
a communication space extending in the lengthwise direction of the lower case and formed between the plurality of battery modules and the side member.

16. The battery case of claim 15, wherein the communication unit is configured to transmit information about the plurality of battery modules to the BMU through the communication space.

17. The battery case of claim 15, further comprising an upper case covering a top of the lower case in which the plurality of battery modules is accommodated, wherein a gap between the plurality of battery modules and the side member is larger than a gap between the plurality of battery modules and the upper case.
